(19) United States
(12) Patent Application Publication
(10) Pub. No.: US 2006/0065343 A1
(43) Pub. Date: Mar. 30, 2006

(54) Manufacture method for liquid crystal display and marks of substrate thereof

(75) Inventor: Yen-Wen Fang, Chu Nan Town (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: HannStar Display Corporation

(21) Appl. No.: 11/093,574

(22) Filed: Mar. 30, 2005

(30) Foreign Application Priority Data
Sep. 29, 2004 (TW) 93129463

(51) Int. Cl. B31B 1/60

(52) U.S. Cl. 156/60

(57) ABSTRACT

A manufacture method for a liquid crystal display device and the marks of a substrate thereof is submitted in this present invention. First, a substrate is provided for marked the marks. Then at least one high power light beam is used to focus on and melt the internal part of the substrate for forming the opaque areas. According to the arrangement of the opaque areas, which can be used as the alignment marks or the identification marks. Due to the position of the opaque areas formed by the high power light beam are accurate, the degree of accuracy in the follow-up assembly operation is improved.

### RELATED APPLICATIONS

The present application is based on, and claims priority from, Taiwan Application Serial Number 93129463, filed Sep. 29, 2004, the disclosure of which is hereby incorporated by reference herein in its entirety.

### FIELD OF THE INVENTION

The present invention is related to a manufacture method for a liquid crystal display, and more particular, to a manufacture method for alignment marks in a substrate of the liquid crystal display.

### BACKGROUND OF THE INVENTION

Liquid crystal display (LCD) is a kind of display employing the characters of liquid crystal display to exhibiting images, cause thereof has more flexibility in dimension and weight compare with cathode ray tube (CRT). Liquid crystal display is employed in various kinds of field, such as mobile phone, personal digital assitant, digital camera, television, and banner advertisement.

The flexibility in dimension and weight compare with cathode ray tube, which is due to the significant parts of the liquid crystal display are flat, such as a thin film transistor array substrate and a color filter substrate. Therefore, it's much easier than cathode ray tube to be cut in appropriate dimension according to a demand, and much lighter and handier than cathode ray tube which has huge three-dimensional shape.

Because the liquid crystal display is manufactured by those stacked flat elements, and a light beam pass through such layered elements to exhibiting images. It is necessary to align the thin film transistor array substrate and color filter substrate accurately during combining them, then the liquid crystal can exhibit images correctly, and avoid to appearing some issues, such as color difference.

The simplest conventional method for alignment and stacking the thin film transistor array substrate and color filter substrate, is to put those substrates both on the alignment device, and use the alignment mechanism as the standard of alignment for stacking process.

Another conventional alignment method is to form some alignment marks at the surrounding or corner area of the thin film transistor array substrate and color filter substrate. Then the location of those substrates is adjusted via the alignment marks during stacking those two substrates. The alignment marks of the thin film transistor array substrate are formed in one process, and the alignment marks of the color filter substrate are form in another process. Those alignment marks are not formed in the same process and simultaneously. The process forming the alignment marks usually means the photolithograph process.

As manufacturing technology development, the thin film transistor array substrate and the color filter substrate becomes larger and larger. The number of thin film transistor array panels and color filter panels separately disposed on the thin film transistor array substrate and the color filter substrate increase as the dimension of those two substrates. While more thin film transistor panels and color filter panels put on the substrates, the accuracy requirement according to the positions of the alignment marks will become more seriously. The conventional alignment methods mentioned above are both limited as the substrate size becoming larger.

For example, while more than eight panels put on the same substrate, the accuracy of the positions of alignment marks will become poor or mistakable. Therefore, this kind of alignment method is limited when the size of the glass substrate becomes larger.

Furthermore, both of the alignment method mentioned above also has a risk of contaminant particle caused by the manufacture process of the alignment marks. Hence, there is a demand existed for an alignment or manufacture method that can provide more accurate and faster alignment method for manufacture the liquid crystal display.

### SUMMARY OF THE INVENTION

One purpose of the present invention is to provide a method that improves the accurate of the alignment process.

Another purpose of the present invention is to provide a method that simplifies the manufacture process of the alignment marks.

Another purpose of the present invention is to provide a method that can form the alignment marks on plural substrates simultaneously in the same process.

Another purpose of the present invention is to provide a method that can manufacture the liquid crystal display without contaminant particle.

In order to achieve the purposes mentioned, the present invention provides a manufacture method of a liquid crystal display, which comprises the steps of: providing a plurality of substrates decided to form the alignment marks on the same places of each substrate; stacking and locating those substrates on a device employed for forming the alignment marks, wherein the alignment marks forming device comprising a high power light beam emitting head used for burning and melting the alignment marks in the internal part of one of the substrates, and burning and melting the same alignment marks in the internal part of another substrates by adjusting the focal point of the high power light beam; and assembling the predetermined substrates via the alignment marks in general alignment and assembly process.

### BRIEF DESCRIPTION OF THE DRAWINGS

FIG. 1 is a sketch of forming an opaque area via a high power light beam on a substrate of one embodiment of the present invention.

FIGS. 2A-2D are sketches of showing the alignment marks formed via the high power light beam on the substrate of another embodiment of the present invention.

FIG. 3A is a sketch of the alignment marks example which formed by the high power light beam on the substrate of another embodiment of the present invention.

FIG. 3B is a sketch of a literal pattern example which formed by the high power light beam on the substrate of another embodiment of the present invention.

FIG. 3C is a sketch of the dot matrix bar code pattern example which formed by the high power light beam on the substrate of another embodiment of the present invention.

FIG. 4 is a vertical view of assembling two substrates of another embodiment of the present invention.

FIG. 5A-5B are sketches of forming the opaque areas via the high power light beam on a plurality of substrates of another embodiment of the present invention.

FIGS. 6A-6F are sketches of showing the alignment marks formed via the high power light beam on a plurality of substrates of another embodiment of the present invention.

FIG. 7A is a sketch of a device which used for forming the marks of another embodiment of the present invention.

FIG. 7B is a sketch of forming the marks via the high power light beam passing through a photo mask of another embodiment of the present invention.

FIG. 8A-8E are sketches of a manufacture method of liquid crystal panel of another embodiment of the present invention.

FIG. 9A-9D are sketches of another manufacture method of liquid crystal panel of the present invention.

FIG. 10 is a flow chart in accordance with the present invention.

### DETAILED DESCRIPTION OF THE INVENTION

The fundamental idea of the present invention is to form the marks in internal part of a substrate of the liquid crystal display by employing the characters of the high power light beam, such as high power, penetrability, and variable focal length. Hence, there are no effects or damages existing on the surface of the substrate, and no contaminant particles formed by the present inventive method. In addition, the marks formed via the present invention can be produced in the successive process, so the risk of errors during the manufacture process of the marks can be reduced.

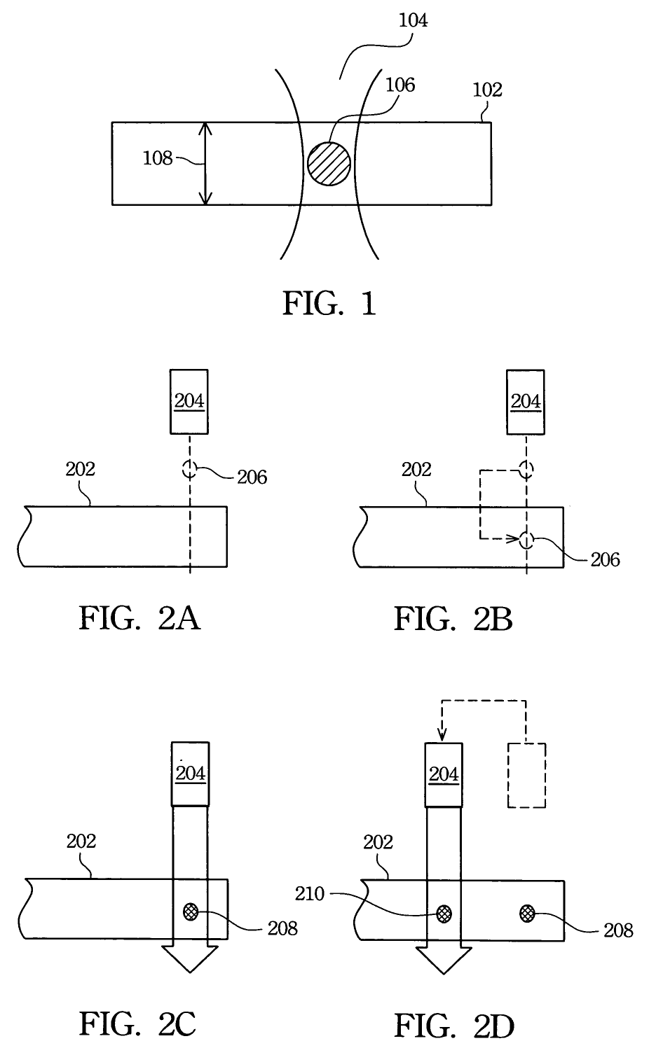

The glass substrates are usually selected as the substrates of the liquid crystal display. For example, the thin film transistor array and the color filter are manufactured via a variety of processes on the glass substrates. Because the glass material is transparent and meltable, as shown in FIG. 1, an ovoid opaque area 106 can be formed in the internal part of the substrate 102 by the heat caused by focusing of a high power light beam 104, such as laser light beam.

The opaque area 106 caused by focusing of the high power light beam 104 should be controlled under the thickness 108 of the substrate 102. If the opaque area 106 is over the thickness 108, the high power light beam 104 can damage the surface of the substrate 102. According to the available laser technology, the dimension of the opaque area 106 can be controlled about 100 μm. In order to make the opaque area 106 totally in the internal part of the substrate 102, the focusing area of the high power light beam 104 is decided by the thickness 108 of the substrate. Preferably, the dimension of the opaque area 106 is suggested smaller than half of the thickness 108. In another words, if there is a major axis existed in the opaque area 106, the major axis is suggested smaller than half of the thickness 108 of the substrate 102. Further, the focusing time of the high power light beam 104 should also be controlled, or the substrate 102 will be deformed by the heat caused by the over focusing time, and the position of the opaque area 106 will be shifted too. The focusing time is according to the high power light beam 104, material of the substrate 102 and other design factors, so it is hard to decide a proper focusing time. Hence, the temperature variation on the surface of the substrate is suggested between 0˜0.5° C. during forming opaque area 106.

FIGS. 2A-2D disclose the present invention, which is employed to forming the opaque area. First, providing a substrate 202 and a high power light beam emitting device 204 as shown in FIG. 2A, the high power light beam emitting device 204 has a focal point 206, that means a high power light beam emitted from the high power light beam emitting device 204 will focus on the focal point 206. In FIG. 2B, the focal point 206 is adjusted into the predetermined position of the substrate 202 for forming the opaque area. As show in FIG. 2C, the high power light beam emitting device 204 emits a high power light beam which burn and melt an opaque area 208 on the position of the adjusted focal point 206. Shifting the high power light beam emitting device 204, an opaque area 210 is formed in another position as shown in FIG. 2D by the same method as described above. Repeating the steps described before, a plurality of opaque areas can be formed in the same substrate and arranged as some designed specific marks.

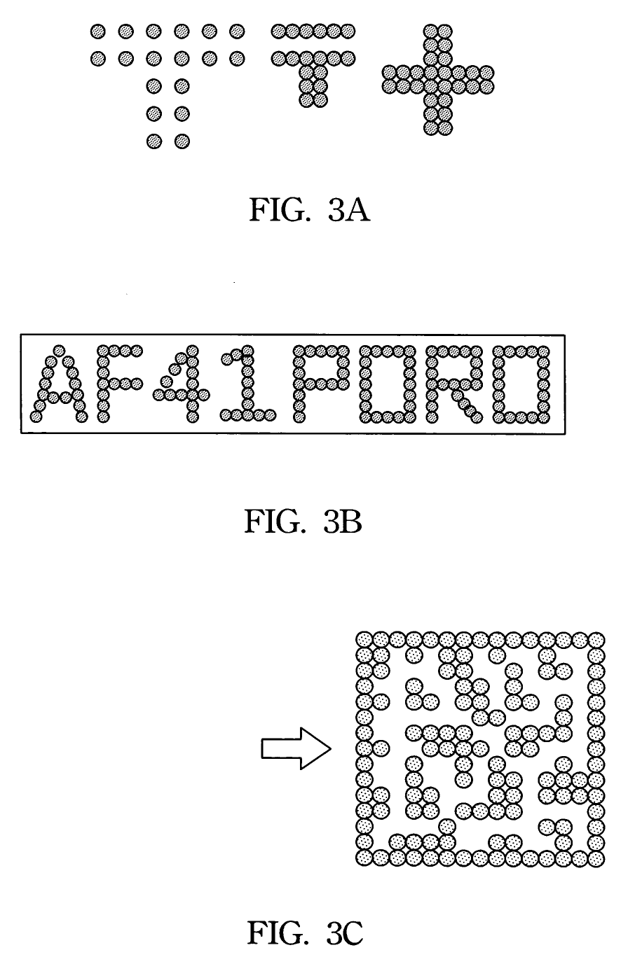

FIG. 3A shows three kinds of alignment marks arranged by the ovoid opaque areas formed by the present invention. Besides the alignment marks, other kinds of marks, for example the glass identification code, is also can be formed by the present invention. FIG. 3B shows a literal pattern and FIG. 3C shows a dot matrix bar code pattern, wherein the left side of FIG. 3C is the original dot matrix bar code pattern, and the right one is the pattern formed by the present invention. Further more, the dot matrix bar code pattern also includes Datamatrix, Maxicode, Vericode, Softstrip, Codel, and Philips Dot Code etc.

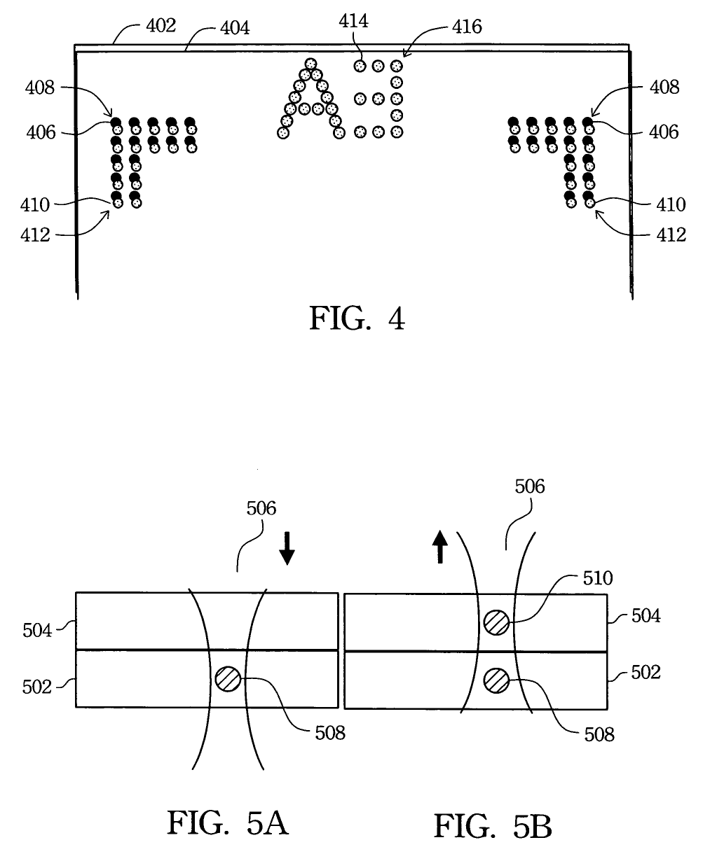

According to FIG. 4, a first substrate 402 and a second substrate 404 are assembled via the alignment marks formed by the present invention, there are a first alignment mark 408 arranged by a plurality of first opaque areas 406 in the internal part of the first substrate 402, and there are a second alignment mark 412 arranged by a plurality of second opaque areas 410 and a glass identification code 416 arranged by a plurality of third opaque areas 414 in the internal part of the second substrate 404. The first alignment mark 408 and the second alignment mark 412 are totally in the same shape, so the first substrate 402 and the second substrate 404 can be assembled accurately by completely overlapping the first alignment mark 408 and the second alignment mark 412. The position of the first alignment mark 408, the second alignment mark 412 and the glass identification code 416 can be formed at the surrounding, corner area or other places of the first substrate 402 and the second substrate 404 without influence the function thereof, and not limited in this embodiment of the present invention.

FIG. 5A and FIG. 5B disclose another embodiment of the present invention, and show the possibility for forming the alignment marks in a plurality of substrates simultaneously in the successive process. According this embodiment, the manufacture time of the alignment marks can be reduced without forming the alignment marks alone in each substrate process, and the errors between each alignment mark can also be reduced. First, as shown in FIG. 5A, if a first substrate 502 and a second substrate 504 will be assembled in follow-up processes, or it's necessary to have the same shape alignment marks in the same positions of the first substrate 502 and the second substrate 504, then as the situations described above, it's suitable to apply this embodiment of the present invention.

First, stacking the first substrate 502 and the second substrate 504, forming a first opaque area 508 in internal part of the first substrate 502 via a high power light beam 506 according to the processes described before, then adjusting the focal length of the high power light beam 506 to focusing inside of the second substrate 504, a second opaque area 510 can be formed in internal part of the second substrate 504 as shown in FIG. 5B, wherein the first opaque area 508 and the second opaque area 510 are formed in the successive process, so the errors between thereof can be reduced.

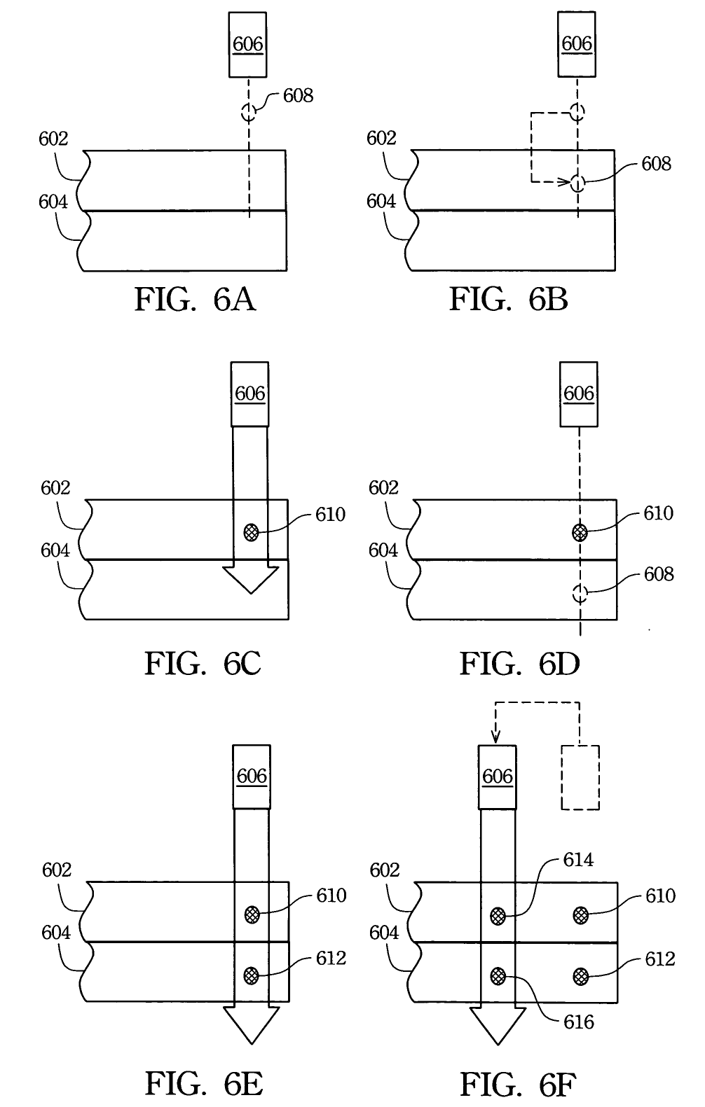

FIGS. 6A-6F describe the detail of this embodiment of the present invention. As shown in FIG. 6A, a first substrate 602 and a second substrate 604 are stacked, and a high power light beam emitting device 606 shifted to a first location, wherein the high power light beam emitting device 606 has a focal point 608. In FIG. 6B, the focal point 608 is adjusted to a predetermined position for forming an opaque area which is in an internal part of the first substrate 602. As shown in FIG. 6C, the high power light beam emitting device 606 emits a high power light beam to burn and melt a first opaque area 610 in the focal point. According to FIG. 6D, the focal point 608 is vertical adjusted into the internal part of the second substrate 604. In FIG. 6E, in the internal part of the second substrate 604, a second opaque area 612 corresponding to the first opaque area 610 is burnt and melted as the same process described before. As shown in FIG. 6F, shifting the high power light beam device 606 to a second location, a third opaque area 614 and a fourth opaque area 616 are respectively formed in different positions of the first substrate 602 and the second substrate 604 by the same method described before. Repeating the steps described above, the totally corresponding alignment marks of the first substrate 602 and the second substrate 604 can be formed.

According to this embodiment of the present invention, the manufacture time of the alignment marks can be reduced by forming in a short time. On the other hand, the manufacture sequence of the opaque areas is not limited in this embodiment. For example, as shown in FIG. 5A and FIG. 5B, forming the second opaque area 510 early and forming the first opaque area 508 latter is acceptable, or as shown in FIG. 6A-6F, forming the second opaque area 610 early and forming the first opaque 608 latter is also acceptable. Further, the number of the stacked substrates for the present invention is not limited in two substrates. In multi-stacked substrates situation, it's suggested to forming the opaque area in the farther substrate from the high power light beam emitting head as earlier as possible, or the opaque area in the closer substrate will interfere with the forming of the opaque area in the farther substrate.

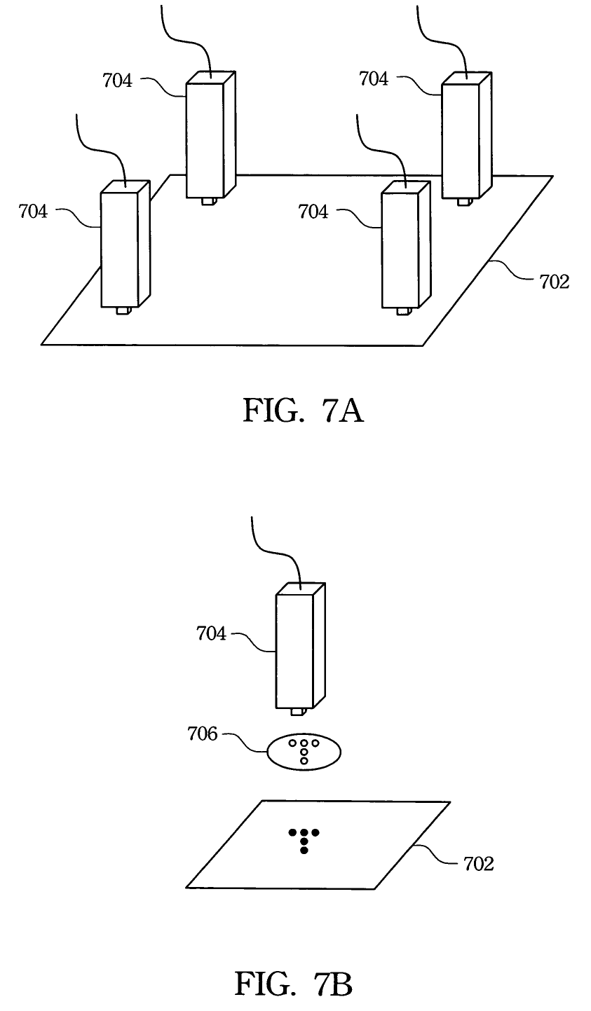

FIG. 7A discloses a device which can achieve the purpose of the present invention, wherein a substrate 702 is deposited in a base (not shown in the figure), and there are a plurality of high power light emitting devices 704 arranged upon the predetermined positions for forming alignment marks of the substrate 702. During manufacturing the alignment marks, these high power light beam emitting devices 704 operate simultaneously for forming the alignment marks in predetermined position of the substrate 702, wherein the alignment marks can also be formed by shifting horizontal shifting the high power light beam device 704 or the base of the device, or as shown in FIG. 7B, employing a photo mask 706 located between the substrate 702 and the high power light emitting device 704 to forming the alignment marks in the same time. In practice, the number or locations of the high power light beam-emitting device are not limited in this embodiment of the present invention.

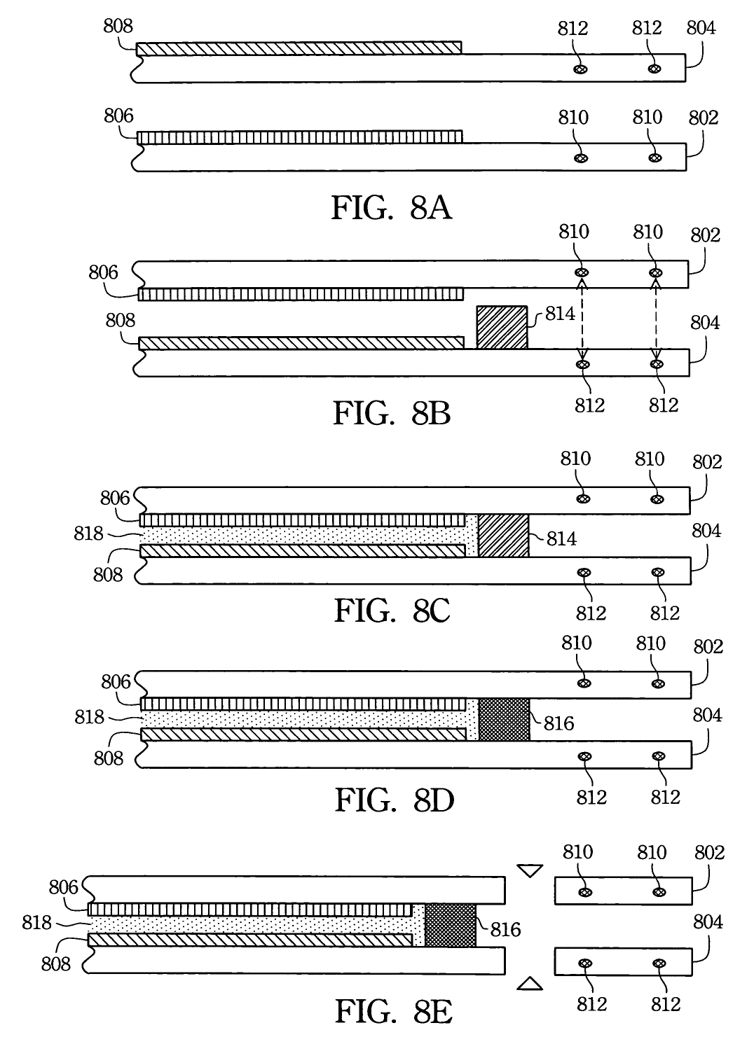

FIGS. 8A-8E show another embodiment of the present invention, which is employed in the alignment marks of the liquid crystal display. As shown in FIG. 8A, a first substrate 802 and a second substrate 804 employed in the liquid crystal display are provided first, then a thin film transistor array structure 806 and a plurality of first alignment marks 810 are formed separately on the surface and in the internal part of the first substrate 802, and a color filter structure 808 and a plurality of second alignment marks 812 are also formed separately on the surface and in the internal part of the second substrate 804, wherein the first alignment marks 810 and the second alignment marks 812 have the same pattern, and both are formed via the manufacture methods of alignment marks described before simultaneously or separately. In FIG. 8B, the first substrate 802 are stacked with the second substrate 804, wherein the first alignment marks 810 are corresponding to the second alignment marks 812. There are a sealant 814 applying between the first substrate 802 and the second substrate 804. In FIG. 8C, a plurality of liquid crystal molecules are injected into the space formed by the first substrate 802, the second substrate 804, and the sealant 814. In FIG. 8D, an end sealant 816 is applied in the sealant 814 to forming a closed seal pattern. At last in FIG. 8E, cutting the part which is not used for displaying image of the first substrate 802 and the second substrate 804, this part may include where the first alignment marks 810 and the second alignment marks 812 disposed. After the process described above, a liquid crystal panel used for liquid crystal display can be manufactured. According to this embodiment, it's also acceptable to form the thin film transistor array structure on the second substrate, the color filter structure on the first substrate, or the color filter integrated with the thin film transistor array structure on one of the first substrate and the second substrate.

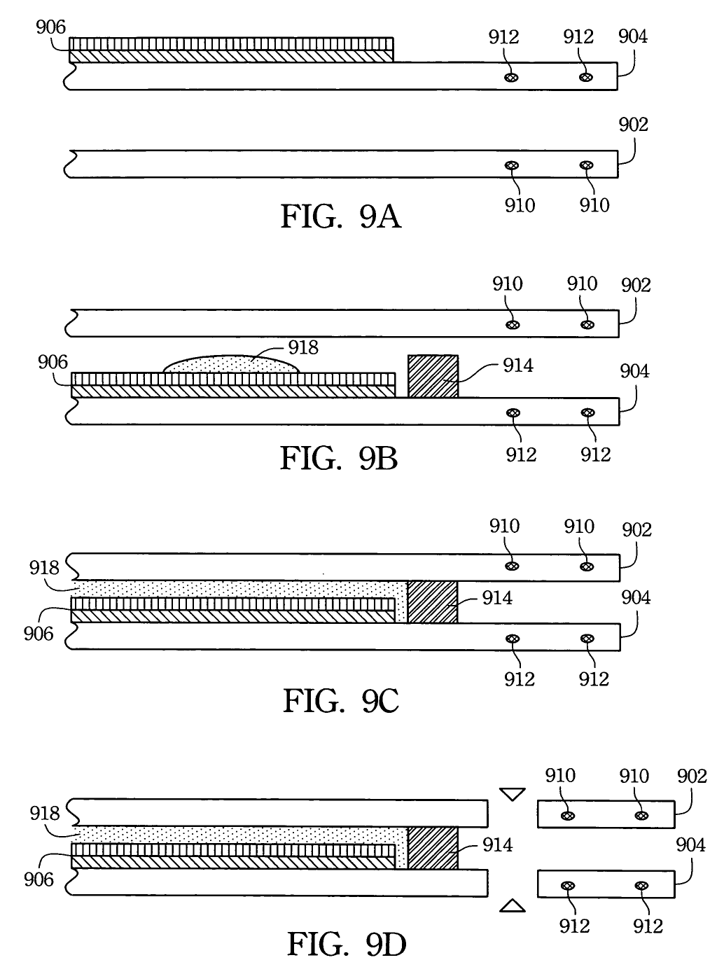

FIGS. 9A-9D show another embodiment of the present invention. In FIG. 9A, first providing a first substrate 902 and a second substrate 904, a first alignment marks 910 composed of a plurality of opaque areas are formed in the internal part of the first substrate 902, and a second alignment marks 912 composed of a plurality of opaque areas are formed in the internal part of the second substrate 904 with a color filter integrated with a thin film transistor array structure 906 on the surface of the second substrate 904, wherein the first alignment marks 910 and the second alignment marks 912 are in the same pattern and formed by the same process which described before. In FIG. 9B, the first substrate 902 are stacked with the second substrate 904, wherein a plurality of drops or enough quantity of liquid crystal molecules 918 are dripped on the second substrate 904, the first alignment marks 910 and the second alignment marks 912 are corresponding to each other, and a sealant 914 is disposed between the first substrate 902 and the second substrate 904 during assembling process. In FIG. 9C, after assembling the first substrate 902 and the second substrate 904, a plurality of liquid crystal molecules 918 are dispensed in the space formed by the first substrate 902, the second substrate 604, and sealant 914. At last in FIG. 9D, cutting the part which is not used for displaying image of the first substrate 902 and the second substrate 904, this part may include where the first alignment marks 910 and the second alignment marks 912 disposed. After the process described above, a liquid crystal panel used for liquid crystal display can be manufactured. According to this embodiment, it's also acceptable to form the thin film transistor array structure on one of the first substrate and the second substrate, and form the color filter structure on another one of the first substrate and the second substrate.

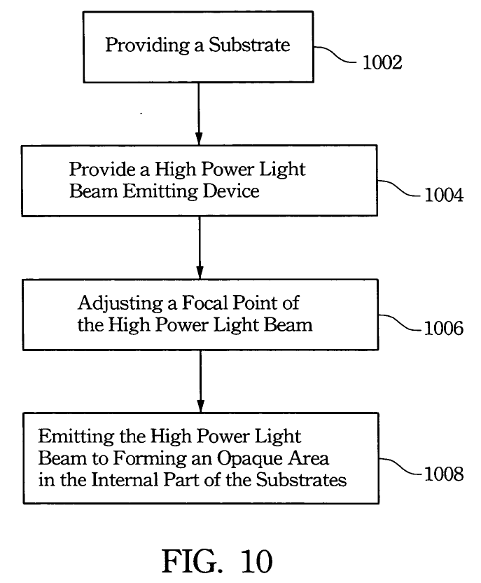

FIG. 10 discloses a flow chart of the present invention. In a first step 1002, a substrate decided to be formed marks is provided, wherein the marks means the alignment marks or the glass identification code. In a second step 1004, a high power light beam-emitting device is provided for forming the marks. In a third step 1006, the high power light beam emitting device is shifted into a proper position, then a focal point of the high power light beam device is adjusted into the internal part of the substrate. In a fourth step 1008, a high power light beam emits form the high power light beam device and form an opaque area in the position where the focal point is in the internal part of the substrate.

Repeating the steps described above, a plurality of marks composed of the opaque areas can be formed in the internal part of the substrate, wherein the high power light beam comprises such as an excimer laser, a solid state laser or other high power light beam which can achieve the same effect, then assembling the substrates via the alignment marks formed by the present invention, wherein the assembling process can be employed the general assembling process.

Having thus described the invention in detail, it will be recognized that such detail need not be strictly adhered to but that various changes and modifications may suggest themselves to one skilled in the art, all falling within the scope and spirit of the present invention, as defined by the subjoined claims.

What is claimed is:

1. A manufacture method of a liquid crystal display, including steps of:
providing a substrate;
providing a high power light beam emitting device for emitting a high power light beam;
shifting the high power light beam emitting device and adjusting a focal point of the high power light beam located in the internal part of the substrate; and
emitting the high power light beam to forming a first opaque area in the focal point.

2. The manufacture method of the liquid crystal display according to claim 1, further comprises:
forming a thin film transistor array structure on the substrate.

3. The manufacture method of the liquid crystal display according to claim 1, further comprises:
forming a color filter structure on the substrate.

4. The manufacture method of the liquid crystal display according to claim 1, further comprises:
forming a color filter integrated with a thin film transistor array structure on the substrate.

5. The manufacture method of the liquid crystal display according to claim 1, wherein the high power light beam is a laser light beam.

6. The manufacture method of the liquid crystal display according to claim 1, wherein the first opaque area is an ovoid area.

7. The manufacture method of the liquid crystal display according to claim 6, wherein the ovoid area has a major axis which less than half of a thickness of the substrate.

8. The manufacture method of the liquid crystal display according to claim 1, further comprises:
shifting the high power light beam emitting device and emitting the high power light beam to forming a second opaque area in the focal point.

9. The manufacture method of the liquid crystal display according to claim 8, wherein the first opaque area and second opaque area make up a pair of alignment marks.

10. The manufacture method of the liquid crystal display according to claim 8, wherein the first opaque area or second opaque area is used as an identification mark.

11. The manufacture method of the liquid crystal display according to claim 10, wherein the identification mark is a literal pattern or a dot matrix bar code pattern.

12. The manufacture method of the liquid crystal display according to claim 1, further comprises:
providing a photo mask located between the high power light beam emitting device and the substrate.

13. The manufacture method of the liquid crystal display according to claim 1, wherein a temperature variation of a surface of the substrate is between 0˜0.5° C. during forming the first opaque area.

14. A manufacture method for a liquid crystal display, including steps of:
providing a first substrate and a second substrate stacked by the first substrate;
providing a high power light beam emitting device for emitting a high power light beam;
adjusting a first focal point of the high power light beam located in the internal part of the first substrate; and
emitting the high power light beam to forming a first opaque area in the first focal point.

15. The manufacture method for the liquid crystal display according to claim 14, further comprises:
adjusting a second focal point of the high power light beam located in the internal part of the second substrate; and
emitting the high power light beam and forming a second opaque area in the second focal point.

16. The manufacture method for the liquid crystal display according to claim 15, further comprises:
forming a thin film transistor array structure on the first substrate; and
forming a color filter structure on the second substrate.

17. The manufacture method for the liquid crystal display according to claim 15, further comprises:
forming a color filter integrated with a thin film transistor array structure on the substrate.

18. The manufacture method for the liquid crystal display according to claim 15, further comprises:
alignment the first opaque area with the second opaque area; and
applying a sealant between the first substrate and the second substrate.

19. The manufacture method for the liquid crystal display according to claim 18, further comprises:
injecting liquid crystal molecules into a space between the first substrate and the second substrate;
end sealing the first substrate and the second substrate; and
separately cutting the first opaque area of the first substrate and the second opaque area of the second substrate.

20. The manufacture method for the liquid crystal display according to claim 18, further comprises:
dropping liquid crystal molecules on the first substrate; and
separately cutting the first opaque area of the first substrate and the second opaque area of the second substrate.
